(19) United States
(12) Patent Application Publication
(10) Pub. No.: US 2017/0185389 A1
(43) Pub. Date: Jun. 29, 2017

(54) UPDATE SYSTEM FOR LINUX OPERATING SYSTEM AND METHOD THEREOF

(71) Applicants: Inventec (Pudong) Technology Corporation, Shanghai (CN); Inventec Corporation, Taipei City (TW)

(72) Inventor: Yue Ge, Shanghai (CN)

(21) Appl. No.: 15/073,542

(22) Filed: Mar. 17, 2016

(30) Foreign Application Priority Data
Dec. 25, 2015 (CN) 201510998077.7

(51) Int. Cl. G06F 9/445; H04L 29/06

(52) U.S. Cl. CPC G06F 8/65; H04L 67/42

(57) ABSTRACT

An update system for the Linux operating system and a method thereof are disclosed. In the system and method, an update program can be obtained via distributed clients, to reduce a server's loading. When updating the operating system, allocation data on a user data sector is backed up and restored, so as to complete the update for the operating system. With the present technical features, the technical effect of backing up and restoring the allocation data on the user data sector, and reducing the loading of the server can be achieved.

### CROSS-REFERENCE TO RELATED APPLICATION

This application claims the benefit of Chinese Patent Application No. 201510998077.7, filed Dec. 25, 2015.

### BACKGROUND OF THE RELATED ART

Technical Field

The present disclosure is related to an update system for an operating system and a method thereof, and particularly to an update system, for the Linux operating system, capable of backing up the allocation data on the user data sector and obtaining the update program via the distributed clients, so as to reduce the loading of a server, and a method thereof.

Related Art

User's allocation information and security authentication information are not preserved in existing process of updating the Linux operating system. After the Linux operating system is updated, the user has to execute the system allocation and the security authentication again, which results in the user's inconvenience in updating the Linux operating system.

Besides, when a server is simultaneously requested by multiple clients for downloading an update program, a server loading of the server storing the update program will be increased. The more the clients, the more the server loadings. However, when the server is overloaded, it may take much time to try to update the operating system, causing an overtime failure in updating the operating system.

In summary, the conventional technology problem of not preserving the user's allocation information and the related security authentication while the Linux operating system is updated, and the server overloading when the multiple clients update the operating system at the same time, has existed for a long time. As a result, it's necessary to propose an improved technology for solving the aforesaid problem.

### SUMMARY

In order to solve the foregoing technical problems of not preserving the user's allocation information and the related security authentication when the Linux operating system is updated, and the server overloading problem when the multiple clients update the operating system at the same time, one objective of the present disclosure is to provide an update system for the Linux operating system and a method thereof.

According to embodiment of the present invention, the update system for the Linux operating system includes a first client, a second client and a server which all are operated under Linux operating system. The first client includes a first transmission module, a first generating module and an execution module. The second client has a storage module, a second transmission module and a second generating module. The server has a server transmission module, a server generating module and a request generating module.

In the first client, the first transmission module is transmitting an update request or a download request or receiving a download instruction or an update program. The first generating module is generating the download request based on the download instruction. When the first transmission module completes to receive the update program and the first client restarts the operating system, the execution module is executing the update program to backup allocation data on a user data sector, format the user data sector and update the Linux kernel and the read-only file system, and then restore the backup allocation data on the user data sector to a new user data sector which is allocated newly, so as to complete the update for the operating system.

In the second client, the storage module is downloading and storing the update program in advance, the second transmission module is receiving a query request, transmitting a query response and loading information, receiving the download request from the first transmission module, or transmitting the update program to the first transmission module. The second generating module of the second client is generating the query response when the second transmission module receives the query request and the storage module stores the update program.

In the server, the server transmission module is receiving the update request from the first transmission module, transmitting the query request to the second transmission module, receiving the query response and the loading information from the second transmission module, or transmitting the download request to the first transmission module. The server generating module of the server is generating the query request when the server transmission module receives the update request. The request generating module of the server is choosing the second client with the minimal loading information to produce the download instruction when the server transmission module receives the query response and the loading information.

The present disclosure provides an update method for the Linux operating system, and the method includes steps of:

providing a first client with the Linux operating system; providing at least one second client configured to download and store an update program in advance; transmitting an update request to a server by the first client; generating a query request and transmitting the query request to the at least one second client by the server based on the update request; generating the query response by the at least one second client based on the query request when the second client stores the update program; transmitting the query response and loading information to the server by the second client; choosing the second client with minimal loading information by the server to generate a download instruction and transmit the download instruction to the first client by the server; generating the download request by the first client based on the download instruction and transmitting the download request to the second client corresponding to the download request; and when the first client completes to receive the update program from the second client and restarts the operating system, executing the update program by the first client to back up allocation data on a user data sector, format the user data sector, and update the Linux kernel and the read-only file system, and then restore the backup allocation data on the user data sector to a new user data sector which is allocated newly, so as to complete the update for the operating system.

The disclosed update system and method thereof are mentioned as above. Unlike the prior arts, the present update system and a method thereof may backup the allocation data on the user data sector, format the user data sector, update the Linux kernel and the read-only file system, and then restore the backup allocation data on the user data sector to a new user data sector which is allocated newly, so as to complete the update for the operating system. Therefore, the update program can be obtained via distributed clients as well, so as to reduce the server loading.

By means of technology of the present disclosure, not only the allocation data on the user data sector may be backed up and restored, but the server loading may be reduced.

### BRIEF DESCRIPTION OF THE DRAWINGS

FIG. 1 illustrates a block diagram of the update system for Linux operating system of the present invention.

FIG. 2A to FIG. 2C illustrate flow charts of the update method for the Linux operating system of the present invention.

FIG. 3 illustrates an architecture diagram of the update system for the Linux operating system of the present invention.

### DETAILED DESCRIPTION

The present invention will be apparent from the following detailed description, which proceeds with reference to the accompanying drawings, wherein the same references relate to the same elements.

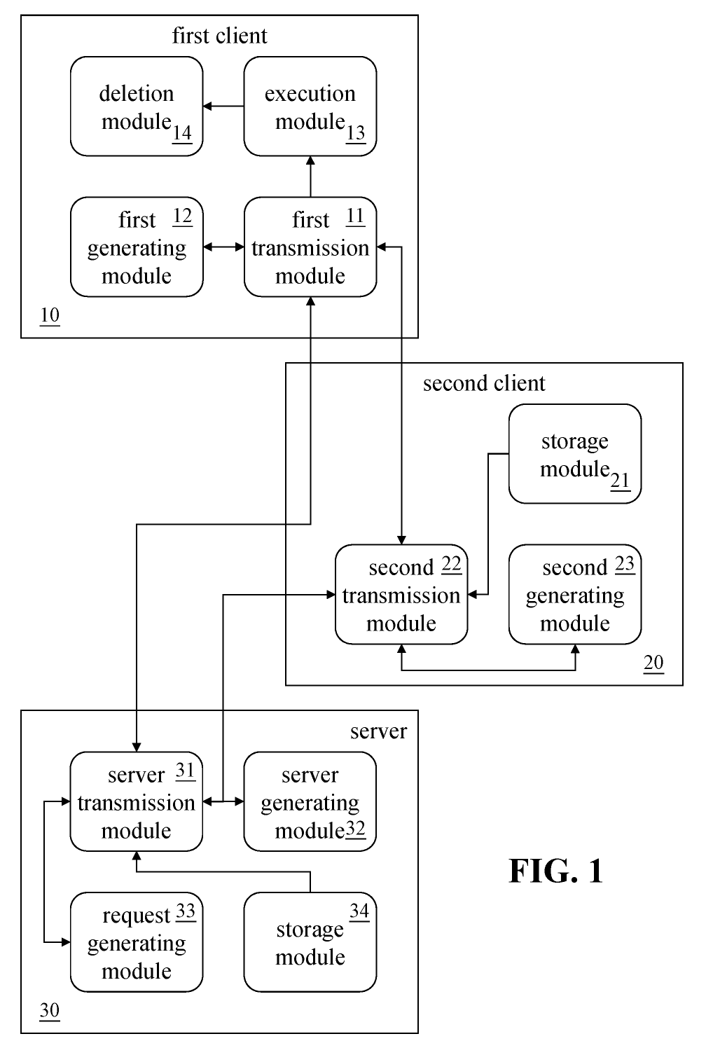

The update system for the Linux operating system of the present invention is presented in the following content first. Please refer to FIG. 1. FIG. 1 illustrates a block diagram of the update system for the Linux operating system of the present invention.

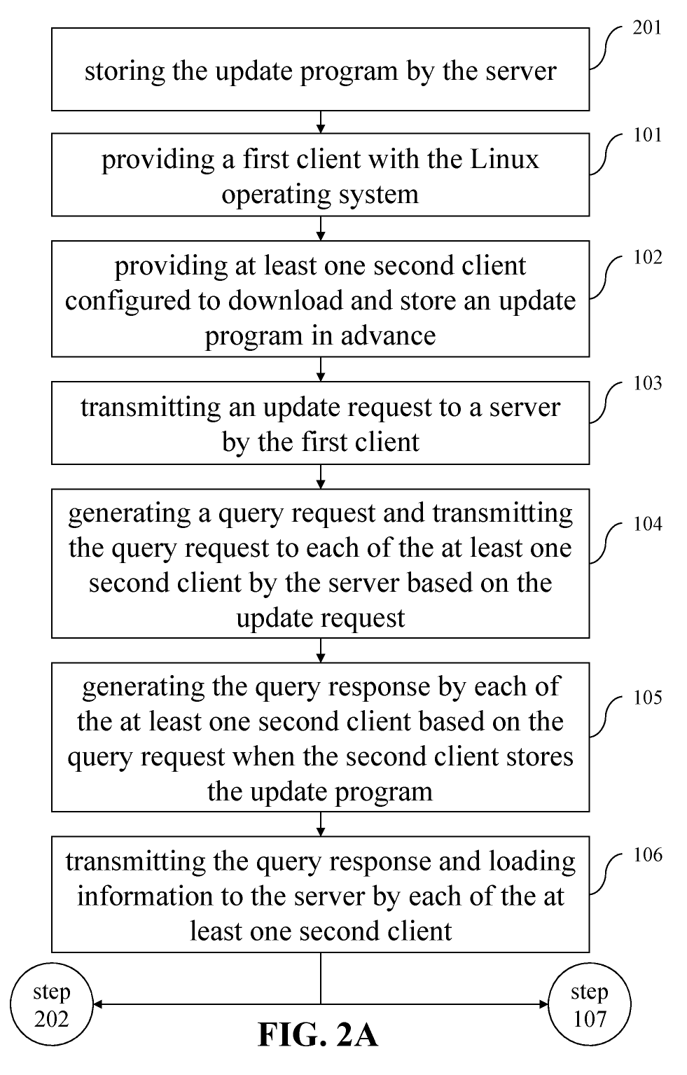

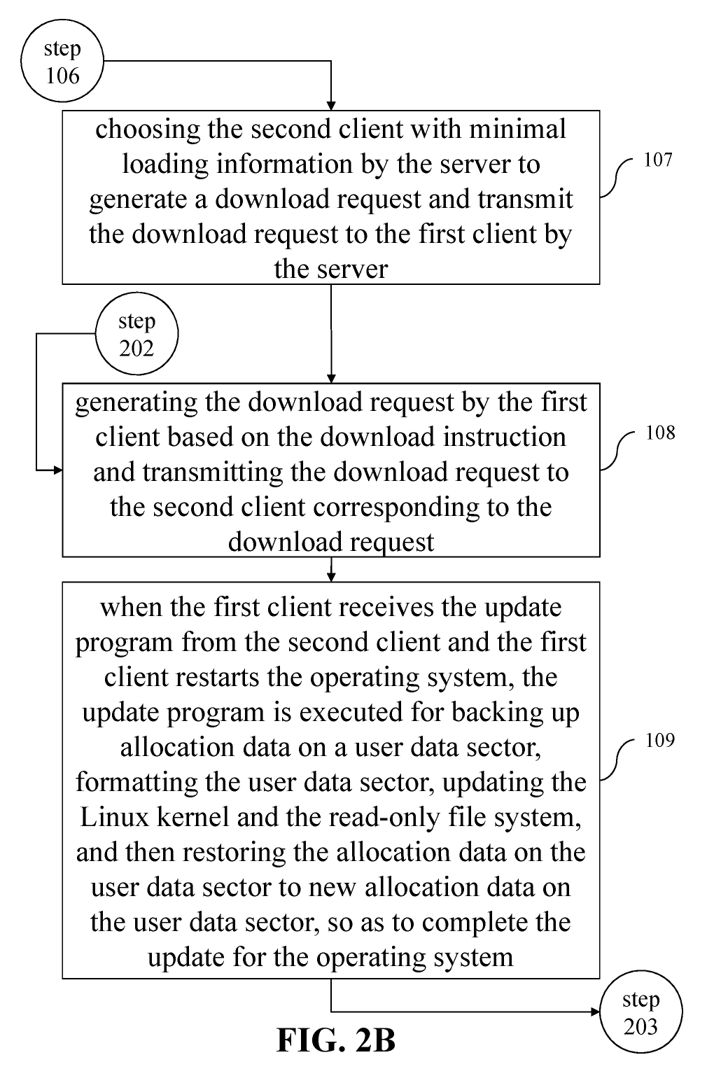

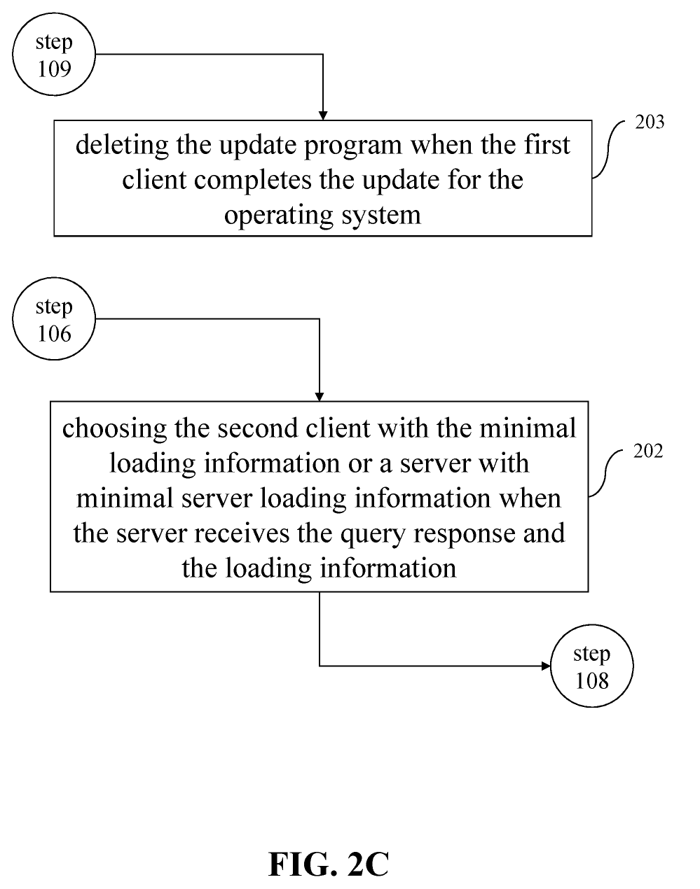

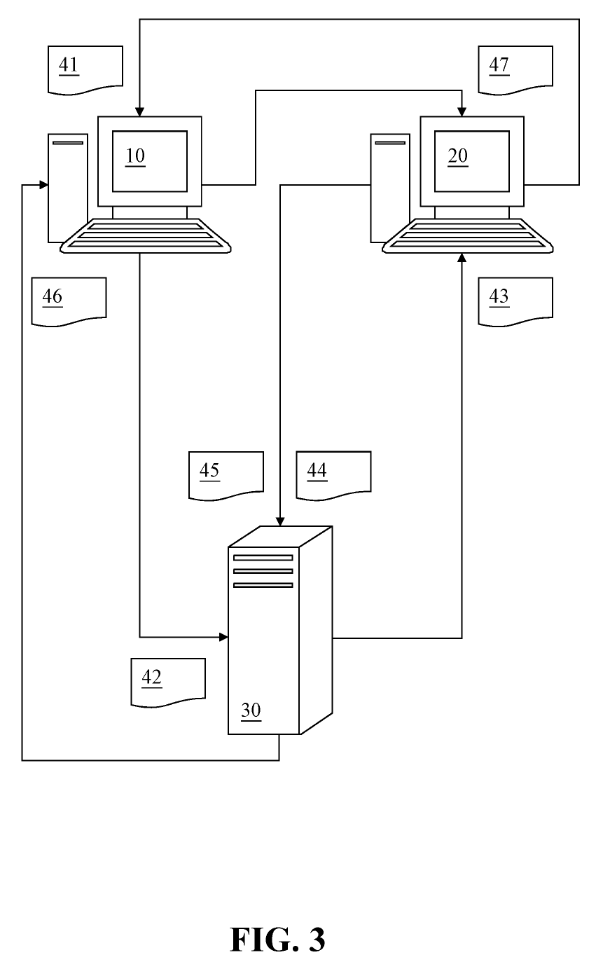

One embodiment will be used for explaining the updating system and the method thereof of the present invention, and please refer to FIG. 1, FIG. 2A, FIG. 2B FIG. 2C, and FIG. 3 at the same time. FIG. 1 illustrates a block diagram of the update system for the Linux operating system of the present invention. FIG. 2A to FIG. 2C illustrate flow charts of the update method for the Linux operating system of the present invention. FIG. 3 illustrates an architecture diagram of the update system for the Linux operating system of the present invention.

The update system for the Linux operating system of the present invention includes a first client 10, a second client 20 and a server 30. The first client 10 includes a first transmission module 11, a first generating module 12 and an execution module 13. The second client 20 includes a storage module 21, a second transmission module 22 and a second generating module 23. The server 30 includes a server transmission module 31, a server generating module 32 and a request generating module 33.

The storage module 21 of the second client 20 is configured to download and store the update program 41 in advance. Another second client 20 or the server 30 may download and store the update program 41 from the storage module 21 of the second client 20. That is, at the step 201, the server 30 may have a storage module 34 configured to store the update program 41 (step 102).

The first client 10 may use the Linux operating system (step 101), and the first client 10 may take initiative in connecting to the server 30 to find out that the operating system of the first client 10 needs to be updated; or, the server 30 may inform the first client 10 that the operating system of the first client 10 needs to be updated. The foregoing is illustrative of exemplary embodiments and is not to be construed as limited to the specific embodiments disclosed.

When the first client 10 understands that the operating system of the first client 10 needs to be updated by an active or passive manner, the first transmission module 11 of the first client 10 transmits the update request 42 to the server 30 by a wired or wireless transmission (step 103). The server 30 may use the server transmission module 31 to receive the update request 42 from the first transmission module 11 of the first client 10. Preferably, the wired transmission includes a wired network and an optical network, and the wireless transmission includes a wireless network and Wi-Fi. The foregoing is illustrative of exemplary embodiments and is not to be construed as limited to the specific embodiments disclosed.

When the server transmission module 31 of the server 30 receives the update request 42 from the first transmission module 11 of the first client 10, the server generating module 32 of the server 30 may generate a query request 43 and transmit the query request 43 to the second the client 20 through the server transmission module 31 of the server 30 by the wired or wireless transmission (step 104). Then, the second client 20 may receive the query request 43 from the server transmission module 31 of the server 30 through the second transmission module 22 of the second client 20. Preferably, the mentioned wired transmission includes a wired network and an optical network, and the wireless transmission includes a wireless network and Wi-Fi. The foregoing is illustrative of exemplary embodiments and is not to be construed as limited to the specific embodiments disclosed.

When the second transmission module 22 of the second client 20 receives the query request 43 from the server transmission module 31 of the server 30 and the storage module 21 of the second client 20 stores the update program 41, the second generating module 23 of the server 30 is configured to generate the query response 44 (step 105). The query response 44 and the loading information 45 of the second client 20 are transmitted to the server 30 through the second transmission module 22 of the second client 20 by the wired or wireless transmission (step 106). Thus, the server 30 use the server transmission module 31 to receive query response 44 and the loading information 45 from the second transmission module 22 of the second client 20.

When the server transmission module 31 of the server 30 receives the query response 44 and the loading information 45 from the second transmission module 22 of the second client 20, the request generating module 33 of the server 30 may choose the second client 20 with the minimal loading information 45 to generate a download instruction 46. The download instruction 46 is used to notice the first client 10 to download the update program 41 from the designated second client 20. The download instruction 46 is transmitted to the first client 10 by the server transmission module 31 of the server 30 (step 107). Then, the first client 10 may receive the download instruction 46 from the server transmission module 31 of the server 30 through the first transmission module 11 of the first client 10.

When the first transmission module 11 of the first client 10 receives the download instruction 46 from the server transmission module 31 of the server 30, the first generating module 12 of the first client 10 may generate the download request 47 based on the download instruction 46, and the first transmission module 11 of the client 10 transmits the download request 47 to the designated second the client 20 by the wired or wireless transmission (step 108). The mentioned wireless transmission may include a wireless network and Wi-Fi. The foregoing is illustrative of exemplary embodiments and is not to be construed as limited to the specific embodiments disclosed.

When the second transmission module 22 of the client 20 receives the download request 47 from the first transmission module 11 of the first client 10, the second transmission module 22 of the second client 20 may transmit the update program 41 to the first client 10. Then, the first client 10 may receive the update program 41 from the second transmission module 22 of the second client 20.

When the first client 10 completes to receive the update program 41 from the second transmission module 22 of the second client 20 and the first client 10 restarts the operating system, the execution module 13 of the first client 10 may execute the update program 41 to back up the allocation data on the user data sector, format the user data sector, update the Linux kernel and the read-only file system, and then restore the backup allocation data on the user data sector to a new user data sector which is allocated newly, so as to complete the update for the operating system (step 109).

After the execution module 13 of the first client 10 completes the update for the operating system, the deletion module 14 of the first client 10 is configured to delete the update program 41 (step 203), to save the storage space of the first client 10.

It's worth noting that when the server transmission module 31 of the server 30 receives the query response 44 and the loading information 45 from the second transmission module 22 of the second client 20, the request generating module 33 of the server 30 may further choose the second client 20 with the minimal loading information 45 or the server 30 with minimal server loading information to generate the download instruction 46 (step 202). The download instruction 46 is used in noticing the first client 10 to download the update program 41 from the designated second client 20 or the designated server 30. And, the following updating process has been described above already, so it will not be repeated here.

It's worth noting that in practice operation the first client 10 may have all functional modules included by the second client 20, and the second client 20 may have all functional modules included by the first client 10 as well, that is, the client 10 and the second client 20 can include the same functional modules. When the client needs to update the operating system, the client is the first client 10; when the client has already downloaded the update program, the client is the second client 20.

As mentioned above, the difference between the present disclosure and the prior arts is that the present disclosure may back up the allocation data on the user data sector, format the user data sector, update the Linux kernel and the read-only file system, and then restore the backup allocation data on the user data sector to a new the user data sector which is allocated newly, so as to complete the update for the operating system. Besides, the present invention can also obtain the update program via the distributed clients, so that the server loading can be reduced.

By the present technical features, the problem of not preserving the user's allocation information and the related security authentication in the Linux operating system, and the server overloading problem caused by executing the updates by the multiple clients at the same time may be overcome. And, by the above technical features, the technical effect of backing up and restoring the allocation data on the user data sector, and reducing the server loading may be achieved as well.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An update system for Linux operating system, comprising:
a first client with the Linux operating system, wherein the first client comprises:
a first transmission module transmitting an update request or a download request, or receiving a download instruction or an update program;
a first generating module generating the download request based on the download instruction; and
an execution module, wherein when the first transmission module completes to receive the update program and the first client restarts the operating system, the execution module is executing the update program to backup allocation data on a user data sector, format the user data sector, update the Linux kernel and the read-only file system, and restore the allocation data on the user data sector to a new user data sector which is allocated newly, so as to complete the update for the operating system;
at least one second client, each of the at least one second client comprising:
a storage module downloading and storing the update program in advance;
a second transmission module receiving a query request, transmitting a query response and loading information, receiving the download request from the first transmission module, or transmitting the update program to the first transmission module; and
a second generating module generating the query response when the second transmission module receives the query request and the storage module stores the update program; and
a server comprising:
a server transmission module receiving the update request from the first transmission module, transmitting the query request to the second transmission module, receiving the query response and the loading information from the second transmission module, or transmitting the download request to the first transmission module;
a server generating module generating the query request when the server transmission module receives the update request; and
a request generating module choosing the second client with the minimal loading information to generate the download instruction when the server transmission module receives the query response and the loading information.

2. The update system for Linux operating system according to claim 1, wherein the server further comprises a server storage module storing the update program.

3. The update system for Linux operating system according to claim 2, wherein when the server transmission module receives the query response and the loading information, the request generating module further chooses the second client with the minimal loading information or the server with the minimal loading information to generate the download instruction.

4. The update system for Linux operating system according to claim 1, wherein the first client further comprises a deletion module deleting the update program when the execution module completes the update for the operating system.

5. The update system for Linux operating system according to claim 1, wherein transmissions among the first client, the second client and the server comprise a wired or wireless transmission, the wired transmission comprises a wired network and an optical network, and the wireless transmission comprises a wireless network and Wi-Fi.

6. An update method for Linux operating system, comprising the steps of:
providing a first client with the Linux operating system;
providing at least one second client configured to download and store an update program in advance;
transmitting an update request to a server by the first client;
generating a query request and transmitting the query request to each of the at least one second client by the server based on the update request;
generating the query response by each of the at least one second client based on the query request when the second client stores the update program;
transmitting the query response and loading information to the server by each of the at least one second client;
choosing the second client with minimal loading information by the server to generate a download request and transmit the download request to the first client by the server;
generating the download request by the first client based on the download instruction and transmitting the download request to the second client corresponding to the download request; and
when the first client receives the update program from the second client and the first client restarts the operating system, the update program is executed for backing up allocation data on a user data sector, formatting the user data sector, updating the Linux kernel and the read-only file system, and then restoring the allocation data on the user data sector to new allocation data on the user data sector, so as to complete the update for the operating system.

7. The update method for Linux operating system according to claim 6, further comprising the step of storing the update program by the server.

8. The update method for Linux operating system according to claim 7, further comprising the step of choosing the second client with the minimal loading information or a server with minimal server loading information when the server receives the query response and the loading information.

9. The update method for Linux operating system according to claim 6, further comprising the step of deleting the update program when the first client completes the update for the operating system.

10. The update method for Linux operating system according to claim 6, wherein transmissions among the first client, the second client and the server comprise a wired or wireless transmission, the wired transmission comprises a wired network and an optical network, and the wireless transmission comprises a wireless network and Wi-Fi.
